(19) United States
(12) Patent Application Publication
(10) Pub. No.: US 2019/0264833 A1
(43) Pub. Date: Aug. 29, 2019

(54) ROLLER

(71) Applicants: TRELLEBORG OFFSHORE UK LTD, Skelmersdale Lancashire (GB); CHEVRON U.S.A. INC, San Ramon, CA (US)

(72) Inventors: Austin Harbison, Skelmersdale (GB); Adam James Grady, Skelmersdale (GB); Sid Merbarkia, Sugarland, TX (US)

(21) Appl. No.: 16/314,433

(22) PCT Filed: Jun. 30, 2017
(86) PCT No.: PCT/GB2017/051921

§ 371 Date: Dec. 30, 2018

(30) Foreign Application Priority Data
Jun. 30, 2016 (GB) 1611387.0

(51) Int. Cl. F16L 1/12

(52) U.S. Cl. CPC F16L 1/123

(57) ABSTRACT

The invention relates to a roller (10) which is to be mounted upon a conduit (12) to be deployed on the seabed. The roller facilitates lateral movement of the conduit. It is able to rotate relative to the conduit when mounted. The roller has an outer face (36) which contacts and rolls upon the seabed in use. The outer face is shaped to provide treads (38).

The present invention relates to a roller for mounting on a conduit for deployment on the seabed.

Pipelines laid upon the seabed are commonly used for the transfer of oil, gas and other fluids. In offshore hydrocarbon extraction, pipelines are often required to span large distances. Pipelines are commonly formed of metal.

Axial expansion and contraction of pipelines due to thermal cycling creates certain technical challenges. Consider the example of a pipeline used to conduct crude oil from a wellhead. The fluids emerging from the well are at considerably elevated temperatures relative to the surrounding water, so that in normal operation the pipeline is much hotter than its surroundings. In the event of a shutdown, the pipeline is cooled by its environment and suffers a consequent axial contraction, which is then reversed when normal operation resumes. To accommodate changes in length of the pipeline, it must be capable of “buckling” to some degree—that is, of moving along its lateral direction to form curves whose radius or extent varies as the pipeline length varies.

It is known to provide a pipeline with buoyancy modules at chosen regions along its length, locally relieving the pipeline's weight and so facilitating its lateral movement. In this way controlled “buckling zones” can be created in which the pipeline is able to curve in a smooth and controlled manner to accommodate changes in its own length.

However, during repeated buckling the modules slide across the seabed laterally and cyclically, and In so doing they displace the material of the seabed beneath which can result in the creation of berms—ridges in the seabed—which can then resist the required lateral motion of the modules and of the pipeline.

To address this problem, U.S. Pat. No. 8,721,222 (Mebarkia et al.) describes a roller module to be fitted to the pipeline. By rolling across the seabed rather than being dragged across it, this module is intended to reduce berm formation. The roller module also acts in the manner of a wheel to reduce friction and so facilitate the required lateral movement. The modules depicted in that document have a plain cylindrical outer surface for rolling upon the seabed.

Further improvements in performance of devices used to control buckling of pipelines remain desirable.

According to the present invention there is a roller in accordance with the appended claims.

Specific embodiments of the present invention will now be described, by way of example only, with reference to the accompanying drawings, in which:

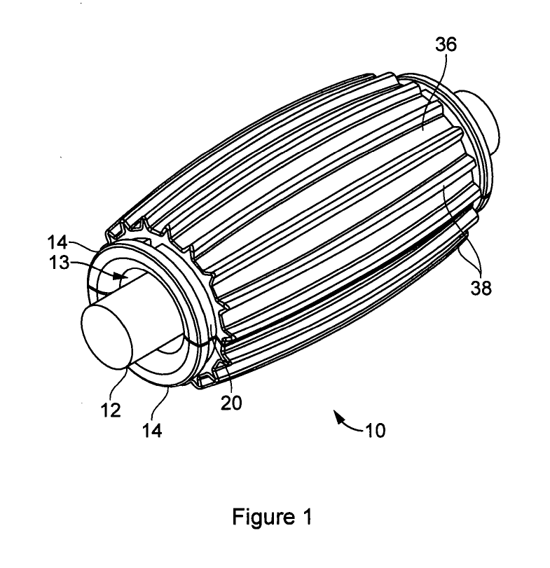

FIG. 1 is a general view of a roller unit embodying the present invention, mounted on a pipeline;

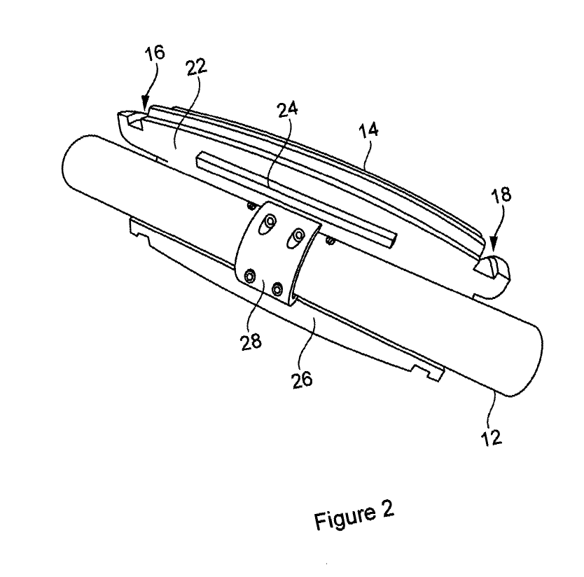

FIG. 2 is a further view of the mounted roller unit from which one roller element has been omitted to reveal internal detail;

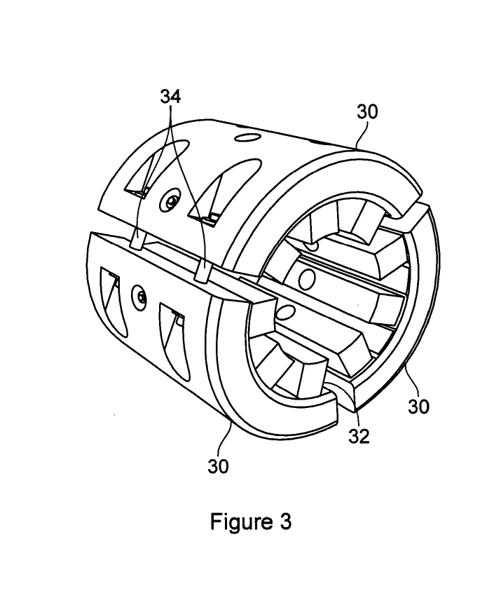

FIG. 3 shows a clamp suitable for use with the roller unit;

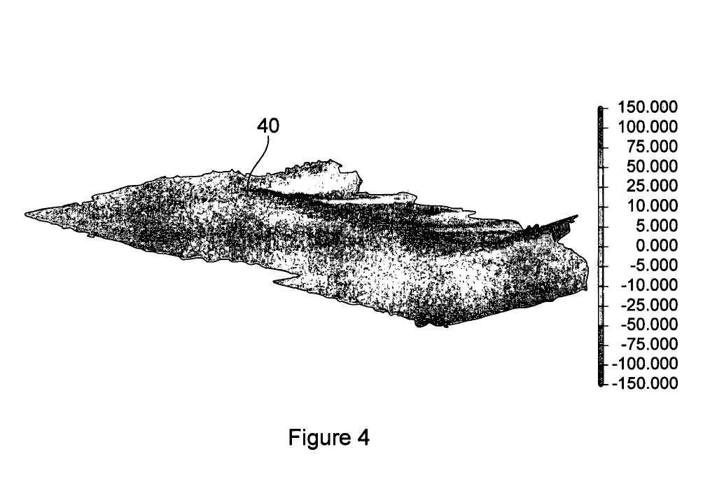

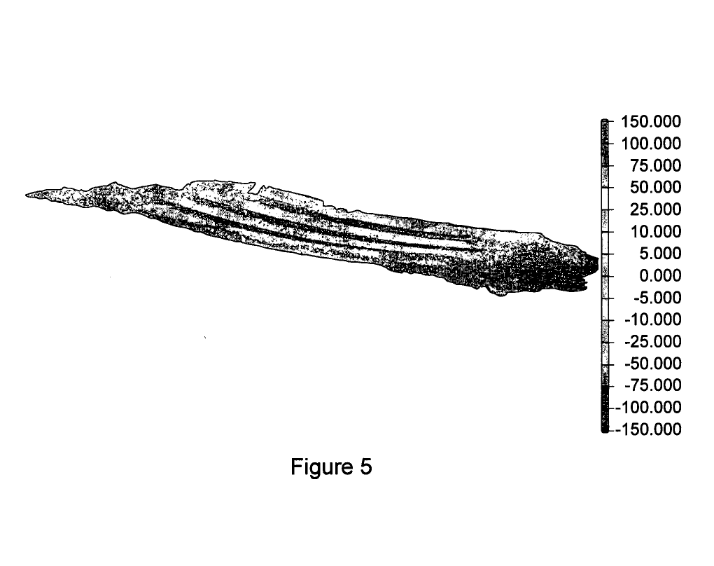

FIGS. 4 and 5 show profiles created in a sand surface in experimental conditions by a plain cylindrical buoyancy unit (FIG. 4) and by a roller unit embodying the present invention (FIG. 5);

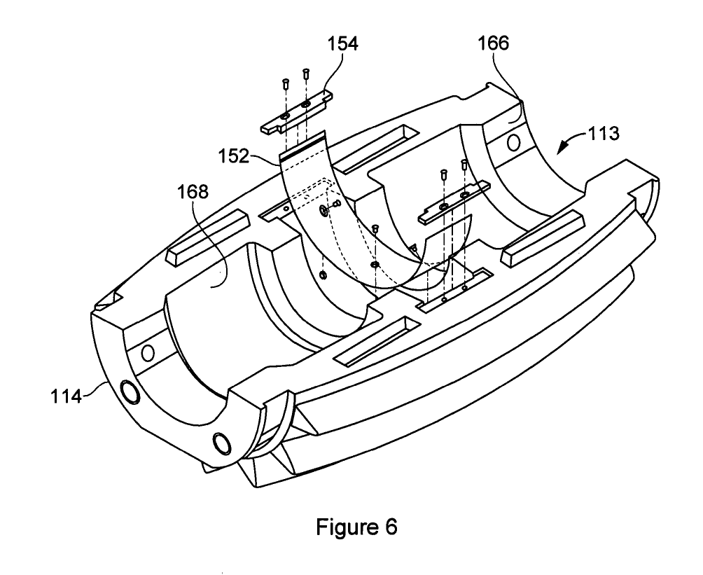

FIG. 6 shows parts of a second roller unit embodying the present invention;

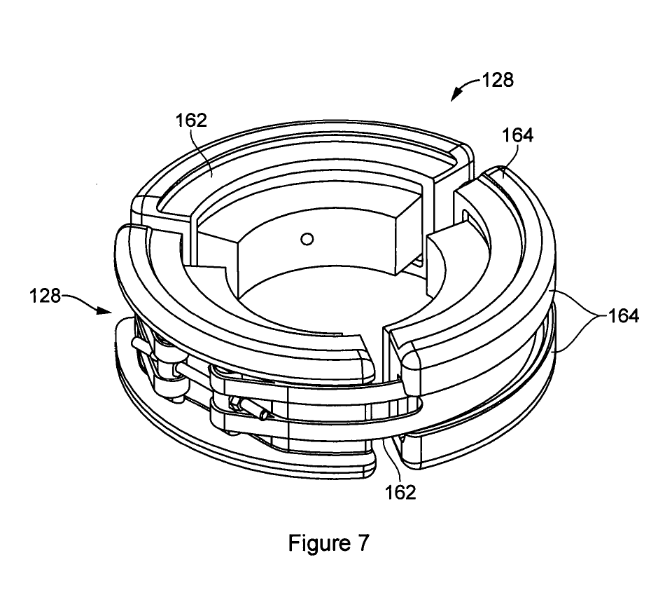

FIG. 7 shows a clamp suitable for use with the second roller unit; and

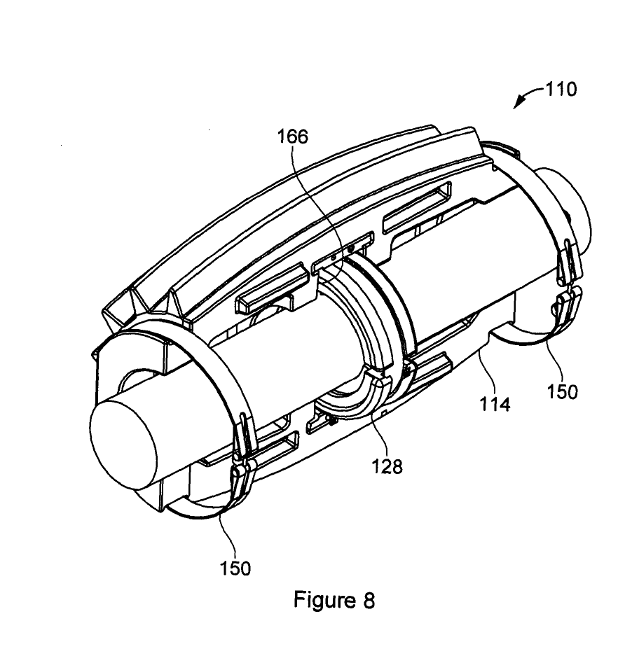

FIG. 8 shows parts of the second roller unit in situ on a pipeline.

The roller unit 10 depicted in FIGS. 1 to 3 is to be mounted on a pipeline 12 deployed on the seabed, to facilitate lateral movement of the pipeline and so enable it to buckle in a controlled, repeatable manner. Note that the term “seabed” is used herein for the sake of brevity but it must be understood that the present invention may be deployed in aquatic environments other than the sea and that the bed in question may for example be that of a lake, an estuary, or another body of water. The roller unit 10 is generally circular in section and forms a through-going passage which receives the pipeline. It will be apparent that the roller unit 10 rotates about an axis which is generally coincident with the longitudinal axis of the pipeline 12.

The main body of the roller unit is formed by multiple roller elements 14. In the present embodiment there are two semi-annular roller elements although this number could be varied in other embodiments. The roller elements 14 are assembled around the pipeline 12, enabling the roller unit 10 to be mounted on the pipeline without a need to pass it over one of the pipeline's ends. Annular recesses 16, 18 at both ends of the roller unit 10 each receive a respective strap 20 which is formed as a loop and is under tension in the assembled roller unit to keep the roller elements together. The straps 20 comprise Kevlar® in the present embodiment. Facing surfaces 22 of the roller elements are provided with complementary registration features to ensure correct alignment. In the illustrated embodiment these comprise an upstanding tongue 24 for receipt in a recess 26. The facing surfaces 22 each also have a semi-cylindrical recess, so that together they form the cylindrical through-going passage 13 to receive the pipeline 12. This passage flares outwardly somewhat towards both its ends to accommodate curvature of the pipeline 12.

A clamp 28 mounted to the pipeline 12 serves to resist movement of the roller unit 10 along the axial direction of the pipeline 12. A clamp suitable for this purpose is depicted in FIG. 3 and comprises in this example three part-tubular clamp bodies 30 to be bolted to one another around the pipeline 12. Spring elements 32 are provided on the inner faces of the clamp bodies 30. In use the clamp bodies 30 are assembled around the pipeline 12 so that the spring elements 32 seat on the pipeline and are compressed as the clamp bodies are drawn together by threaded fasteners 34, creating a clamping force which prevents the clamp 28 from moving along the pipeline 12. The clamp 28 is received in a pocket of enlarged diameter within the cylindrical passage 13, so that the roller unit 10 can rotate about the clamp but is prevented from moving significantly along the pipeline 12.

Materials may be chosen to provide low friction upon rotation of the roller unit 10. The roller elements 14 of the illustrated embodiment comprise an outer shell of plastics material filled with a core of composite material. The outer shell of the present embodiment is formed by rotational moulding. It comprises polyethylene. The shell is filled with syntactic foam, which is a composite of settable plastics material with density reducing elements comprising hollow glass microspheres and larger hollow macrospheres. Other materials could be adopted, however.

The roller elements 14 are buoyant and so help to relieve weight of the pipeline 12 and to facilitate its movement.

The roller unit 10 contacts the seabed through its outer surface 36, which is provided with treads. The term “tread” as used in this description and in the appended claims refers to features of shape on the exterior surface 36 which deviate from a plain cylindrical form and which contribute to traction between the roller unit 10 and the seabed. In this way the treads help to ensure that the roller unit 10 actually rolls across the seabed rather than being dragged across it whilst rotationally static. In the present embodiment the treads take the form of strakes 38 upstanding from the otherwise circular outer surface 36 and running parallel to the rotational axis of the roller unit 10. They may also be accurately referred to as grousers. On a soft seabed the strakes 38 penetrate into the surface, and so resist lateral movement with respect to it, greatly contributing to traction. The material forming the seabed may in practice be highly fluidised, especially at depth. The strakes 38 are found to provide an effective way to promote the required rolling movement of the roller unit 10 in this challenging environment.

The shape of the strakes 38 is convergent in the radially outward direction. In the illustrated examples they have an inverted “V” shape viewed in cross section. Their profile may be referred to as “delta” shaped. One advantage of this profile is that it is capable of easy release from a mould during manufacture. It can also help to shed the soil of the seabed from the roller unit 10 as the unit rolls. This is important since if the unit collects soil which weights it asymmetrically, this weight may resist the desired rolling motion of the roller unit 10. Penetration of the strakes 38 into the seabed can increase the unit's bearing capacity.

The form of the strakes 38 may be designed with reference to the nature of the seabed in the region where the roller unit 10 is to be deployed. The number of strakes 38 around the circumference of the unit and their height (i.e. their dimension along the radial direction) may be selected for this purpose. Typically the height of the strakes 38 is in the region between 5 and 25% of the diameter of the roller unit 10. In the present embodiment the strake height is roughly 10% of the unit's diameter. The number of strakes around the unit's circumference may, without limitation, be from six or eight to twenty or more.

It must be appreciated that the tread may take a variety of different forms commensurate with its function in providing traction. A wide range of different grouser types and formations is known to those skilled in the art and could be adopted, but a whole range of different formations could alternatively be used, including without limitation arrangements of spikes or pimples, axial or helical strakes, fins, spikes or teeth, or upstands, or possibly female features such as recesses, troughs etc.

The profile of the roller unit 10 is cambered—viewed along a radial direction it is convex, so that the radius at the ends of the roller units 10 is smaller than the radius intermediate the ends. Both the strakes 38 and the circular outer surface 36 have this camber. The camber takes the form of a smooth convex curve in the present embodiment. The camber is found to have several advantages compared with a constant diameter profile:

i. it assists in limiting embedment of the roller unit 10 into the seabed, avoiding a tendency for local loading at one end or the other of the unit to cause that end to dig into the seabed;

ii. it assists in providing a smooth touchdown on the seabed during deployment, again helping to distribute loading across the seabed and reducing embedment;

iii. it facilitates longitudinal movement of the roller unit 10. If the unit had a constant diameter and hence had large flat end faces, these might themselves raise seabed material during longitudinal movement. This tendency is reduced due to the cambered profile.

In some embodiments the roller unit 10 is formed in such a manner as to promote shedding of seabed material from its exterior. If material is captured by the treads or adheres to the roller surface, it may impair the roller's function. This may be because the treads become clogged, or because the weight of the captured material acts asymmetrically on the roller and inhibits its rotation. To ameliorate any such problem the treads may be designed in such a manner as to shed material, e.g. because any spaces between treads are outwardly divergent in form. Additionally or alternatively circumferentially extending features, such as fins or grooves, may be provided to break up pieces of collected material and so promote their shedding. The roller unit 10 may have an exterior surface formed of low adhesion and/or low friction material, such as PTFE. It may have a hydrophilic surface.

In other embodiments traction may be the higher priority, and the roller unit 10 may have an external finish selected to provide high traction. It may comprise material which is soft and resilient enough to deform in a manner which improves traction, in the manner of a vehicle tyre. The material in question may be an elastomer. It may comprise rubber.

FIG. 4 shows a profile created in sand, under experimental conditions, by moving a loaded plain cylindrical buoyancy unit across the sand surface. It can be seen that a pronounced berm 40 has been raised, which would—under real world conditions —potentially resist subsequent lateral movement of the buoyancy unit. Compare this with FIG. 5, showing the profile created in testing of the roller unit described above. This shows a pronounced, shallow ripple formed by the strakes 38, but this is too small to interfere with the unit's motion, and more importantly there is no sign of a berm at the extreme of the roller unit's motion.

FIGS. 5 to 8 show a second roller unit 110 embodying the present invention, which is a development of the first roller unit 10 and which like the first comprises a pair of semi-annular roller elements 114 to be assembled to one another about the pipeline. FIG. 8 shows a pair of straps 150 which are disposed and tensioned around respective end regions of the roller elements 114 to secure them together. An insert 152 is provided within the element's passage 113, providing a low friction surface through which the roller unit 110 contacts clamp 128 within. In the present embodiment this insert takes the form of a semi-annular sheet of ultra-high molecular weight polyethylene whose ends are secured by end fittings 154. Other materials could be used for the insert 152. Suitable materials include nylon, PTFE and polyethylene. The low friction properties of the insert promote rolling of the unit 110 relative to the pipeline within. The roller unit 110 engages with the pipeline only though the clamp 128, and does not contact the pipeline directly.

The clamp 128 has an exterior channel 160 receiving a band 162 used to secure it in position on the pipeline. Radial bearing faces 164 on either side of the channel 160 are reduced in area by the channel 160, giving low friction where they contact the surrounding insert 152. End faces of the clamp are cut away at 162 forming end bearing faces 164 which are also reduced in area to minimise friction where they abut locating faces 166 of the roller unit 110.

The roller elements 114 are shaped to provide internal reinforcement ridges 166 within the straps 150, to sustain the loading applied by the straps. Between these are cavities 168 which are water filled, in use. These, and the channel section of the members forming the clamp 128, allow passage of water through the unit, helping to ensure that its internal spaces do not become clogged with material from the seabed in a manner which might impair rotation.

Numerous variants are possible without departing from the scope of the present invention as claimed. In place of the straps 20 used to secure the roller elements 14 to one another, other embodiments may for example used threaded fasteners such as bolts for this purpose, and/or the roller elements 14 may be formed in such a manner as to “snap fit” together, or provided with interlocking formations such as sliding dovetails.

Means other than the clamp 28 may be used to axially locate the roller unit 10. For example, the roller unit could be provided with one or more internal ridges shaped to directly engage the pipeline 12. These ridges may have narrow peaks able to adequately restrict axial movement of the roller unit while still providing sufficiently low friction to facilitate roller rotation. In certain applications the pipeline 12 could be provided with features of shape to axially locate the roller unit. Where a clamp is used, it may take any of a variety of different forms commensurate with its function of axially locating the roller unit 10.

Bearings may be provided between the roller unit and the pipeline 12, to facilitate rotation. Axial location of the roller unit 10 may be made by means of the bearings. These may be in the form of roller or ball bearings. They may comprise low friction rings. They may be plain bearings.

In the present embodiment the roller units 14 serve a dual function, providing both buoyancy and the roller function. In other embodiments these functions may be performed by separate components. For example a radially inner part of the unit may provide the volume needed to contribute buoyancy, being fixed to the pipeline 12, and a radially outer part around the inner part may be rotatable about it to provide the roller function. Still other embodiments may not contribute buoyancy.

The mode of manufacture of the roller elements may be different in other embodiments. For example in place of the integrally formed strakes 38 of the illustrated embodiment, other embodiments could use treads which are adhered or otherwise secured to the exterior of the roller unit.

1. A roller configured for mounting on a conduit to be deployed on the seabed to facilitate lateral movement of the conduit, the roller being able to rotate relative to the conduit when mounted, and having an outer face for contacting and rolling upon the seabed, wherein the roller's outer face is shaped to provide treads.

2. The roller as claimed in claim 1 which is buoyant.

3. The roller as claimed in claim 1, wherein the roller includes two or more roller elements for assembly around the conduit, the roller elements together forming a through-going passage for receiving the conduit.

4. The roller as claimed in claim 1, wherein the treads comprise grousers.

5. The roller as claimed in claim 1, wherein the treads comprise strakes upstanding from the roller's outer face.

6. The roller as claimed in claim 5, wherein the roller rotates about an axis and the treads extend parallel to the axis.

7. The roller as claimed in claim 5, wherein the strakes have a cross sectional shape which is convergent in a radially outward direction.

8. The roller as claimed in claim 5, wherein the strakes have a delta shape in cross section.

9. The roller as claimed in claim 1, wherein the treads have a height along a radial direction which is between 5% and 25% of the diameter of the roller unit.

10. The roller as claimed in claim 1 has a convex profile, viewed along a radial direction.

11. The roller as claimed in claim 10, wherein the convex profile is arcuate.

12. The roller as claimed in claim 1, wherein the roller has an internal cavity for receiving a clamp mounted on the conduit.

13. The roller as claimed in claim 12, wherein the internal cavity has a radially inwardly facing bearing surface for running upon the clamp.

14. The roller as claimed in claim 13, wherein the radially inwardly facing bearing surface comprises low friction material.

15. The roller as claimed in claim 13, wherein the radially inwardly facing bearing surface is formed by an insert.

16. The roller as claimed in claim 1 further comprising a clamp for mounting upon the conduit to axially constrain the roller.

17. An installation comprising a conduit and a roller as claimed in claim 1.

18. The installation as claimed in claim 17 deployed on a seabed.
